(19) United States
(12) Patent Application Publication
(10) Pub. No.: US 2026/0273431 A1
(43) Pub. Date: Sep. 17, 2026

(54) FAUCET TOY IMPLEMENTING CIRCULATING WATER OUTFLOW

(71) Applicant: Goldlok ZhiChen Cultural Creativity (ShenZhen) Co., Ltd., Shenzhen (CN)

(72) Inventor: Gengyang CHEN, Shenzhen (CN)

(73) Assignee: Goldlok ZhiChen Cultural Creativity (ShenZhen) Co., Ltd., Shenzhen (CN)

(21) Appl. No.: 19/191,290

(22) Filed: Apr. 28, 2025

(30) Foreign Application Priority Data
Jan. 16, 2025 (CN) 202510066903.8

(51) Int. Cl. A63H 33/30; F16K 31/02

(52) U.S. Cl. CPC A63H 33/30; F16K 31/02

(57) ABSTRACT

A faucet toy implementing circulating water outflow includes a base and an upper cover. A faucet and a water leakage piston are arranged on two sides of the upper cover respectively. A first valve mechanism, a second valve mechanism, a water pump mechanism, and a waterproof switch mechanism are arranged in an inner cavity defined by the base and the upper cover. According to the present application, functions of turning on the faucet for water outflow and pressing the water leakage piston for water draining can be implemented, and not only can internal and external bidirectional waterproofing of the power supply mechanism be implemented, but also the technical problem that water outflow from the faucet is intermittent due to air inclusion during water pumping can be solved.

### CROSS-REFERENCE TO RELATED APPLICATIONS

This application claims priority to Chinese Patent Application No. 202510066903.8, filed on Jan. 16, 2025, the content of which is incorporated herein by reference in its entirety.

### TECHNICAL FIELD

The present application relates to a toy, and in particular, to a faucet toy implementing circulating water outflow.

### BACKGROUND

A faucet toy is a common toy for playing houses, which truly imitates a shape of a real faucet and can be used as a prop for children to simulate a scenario for playing houses. Most of existing faucet toys are only similar to the real faucet in shape, and generally do not have the same function of water outflow as the real faucet, and do not have the same function of draining water as a real water leakage piston. Therefore, a faucet toy implementing circulating water outflow is provided.

### SUMMARY

An objective of the present application is to overcome the shortcomings of the prior art and provide a faucet toy implementing circulating water outflow.

To achieve the above objective, the following technical solutions are adopted in the present application. A faucet toy implementing circulating water outflow includes a base and an upper cover covering above the base, where a faucet and a water leakage piston are arranged on two sides of the upper cover respectively, a first valve mechanism, a second valve mechanism, and a water pump mechanism are arranged in an inner cavity defined by the base and the upper cover, a waterproof switch mechanism is arranged between the first valve mechanism and the second valve mechanism, a first driving member for driving the first valve mechanism is arranged below the faucet, and when the first driving member drives the first valve mechanism, the first driving member presses and contacts a first travel switch of the waterproof switch mechanism; a second driving member for driving the second valve mechanism is arranged below the water leakage piston, and when the second driving member drives the second valve mechanism, the second driving member presses and contacts a second travel switch of the waterproof switch mechanism; and the waterproof switch mechanism includes a switch body, the waterproof switch mechanism communicates with a power supply mechanism through respective wiring holes, the base is provided with an outer recessed cavity for accommodating the power supply mechanism, a water outlet of the water pump mechanism communicates with a main water pipe, two sides of the main water pipe communicate and are provided with a first branch pipe and a second branch pipe respectively, the first branch pipe communicates with the faucet through the first valve mechanism, and the second branch pipe communicates with the water leakage piston through the second valve mechanism.

Further, the switch body of the waterproof switch mechanism is provided with a first wiring port, a second wiring port is provided at the outer recessed cavity, the first wiring port of the switch body communicates with the second wiring port of the base, and a first waterproof sealing ring is sandwiched between the base and the switch body.

Further, a second cover plate is arranged at the outer recessed cavity of the base, and a second waterproof sealing ring is sandwiched between the second cover plate and the base.

Further, a left side and a right side of the switch body are provided with lateral grooves for placing travel switches, each of the lateral grooves is covered with a key cap, the travel switches each are enclosed in a cavity formed by the key cap and the switch body, a side sealing cover for buckling a periphery of the key cap is arranged on each of the left side and the right side of the switch body, and the side sealing cover is fixedly connected to the switch body.

Further, the first valve mechanism includes a first valve body, an upper end of a valve cavity of the first valve body communicates with a water outlet pipe of the faucet, a left side end of the valve cavity of the first valve body communicates with the first branch pipe, a first pull rod member is slidably arranged at a right side end of the valve cavity of the first valve body, the first pull rod member is sleeved with a first return spring, the first pull rod member is movably connected to the first driving member, a first blocking plug is arranged at a left rod end of the first pull rod member, and a right rod end of the first pull rod member is configured to press and contact the waterproof switch mechanism.

Further, the first driving member is provided with a first fulcrum portion, a first pressing arm portion, and a first warped arm portion, the first fulcrum portion is hinged to the upper cover, the first pressing arm portion abuts against a rocker switch mechanism of the faucet, and the first warped arm portion drives the first pull rod member to slide at the first valve body.

Further, the second valve mechanism includes a second valve body, an upper end of a valve cavity of the second valve body communicates with the water leakage piston, a right side end of the valve cavity of the second valve body communicates with the second branch pipe, a second pull rod member is slidably arranged at a left side end of the valve cavity of the second valve body, the second pull rod member is sleeved with a second return spring, the second pull rod member is movably connected to the second driving member, a second blocking plug is arranged at a right rod end of the second pull rod member, and a left rod end of the second pull rod member is configured to press and contact the waterproof switch mechanism.

Further, the second driving member is provided with a second fulcrum portion, a second pressing arm portion, and a second warped arm portion, the first fulcrum portion is hinged to the upper cover, the second pressing arm portion abuts against the water leakage piston, and the second warped arm portion drives the second pull rod member to slide at the second valve body.

Further, the water pump mechanism is arranged on the base, the water pump mechanism includes a water pump housing and a water pump cap, the water pump cap is arranged below the water pump housing, and a side wall of the water pump cap is provided with an exhaust port; and a motor and a turntable member arranged below the motor are arranged in the water pump housing, the turntable member is connected to a motor shaft of the motor, a rotating impeller is arranged in the water pump cap, the turntable member is provided with a first magnet, a second magnet magnetically attracted to the first magnet is arranged in the rotating impeller, and the turntable member drives the rotating impeller to rotate synchronously when rotating.

Further, a showerhead assembly is arranged on an end portion of a water outlet pipe of the faucet, the showerhead assembly includes a water pipe connector and a showerhead member, an upper end of the water pipe connector is connected to the water outlet pipe, and a lower end of the water pipe connector is snap-fitted with the showerhead member.

The present application has the following beneficial effects: according to the present application, functions of turning on the faucet for water outflow and pressing the water leakage piston for water draining can be implemented, and not only can internal and external bidirectional waterproofing of the power supply mechanism be implemented, but also the technical problem that water outflow from the faucet is intermittent due to air inclusion during water pumping can be solved.

### BRIEF DESCRIPTION OF THE DRAWINGS

FIG. 1 is a schematic diagram of a structure of the present application.

FIG. 2 is a top view of the present application.

FIG. 3 is a sectional view taken along A-A of FIG. 2.

FIG. 4 is a perspective sectional view of the present application.

FIG. 5 is a perspective sectional view of the present application.

FIG. 6 is a perspective sectional view of the present application.

FIG. 7 is a schematic exploded view of a structure of the present application.

FIG. 8 is a schematic exploded view of a structure of the present application.

FIG. 9 is a schematic diagram of a structure of a base.

FIG. 10 is a schematic exploded view of a structure of a waterproof switch mechanism.

FIG. 11 is a schematic diagram of a structure of a water pump mechanism.

FIG. 12 is a sectional view of a structure of a water pump mechanism.

FIG. 13 is an assembly and disassembly diagram of a water pipe connector and a showerhead member.

### DETAILED DESCRIPTION OF THE EMBODIMENTS

To make the objectives, technical solutions, and advantages of the present application clearer, the present application is further described in detail below with reference to the accompanying drawings.

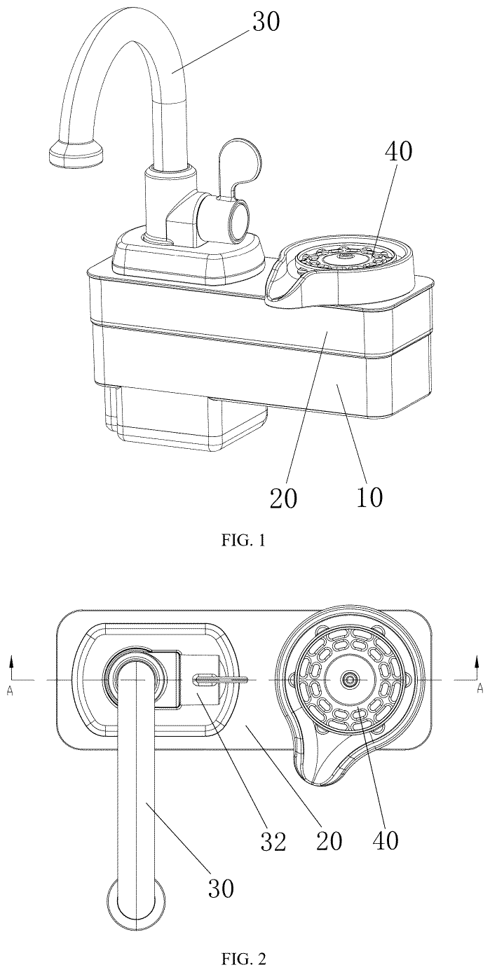

As shown in FIG. 1 to FIG. 3, a faucet toy implementing circulating water outflow includes a base 10 and an upper cover 20 covering above the base 10. A faucet 30 and a water leakage piston 40 are arranged on two sides of the upper cover 20 respectively. A compression spring 41 is specifically arranged between the water leakage piston 40 and the upper cover 20. When the water leakage piston 40 is pressed downward, the compression spring 41 is elastically deformed. When the downward pressure on the water leakage piston 40 is removed, the compression spring 41 recovers from the elastic deformation and pushes the water leakage piston 40 upward to cause the water leakage piston 40 to return.

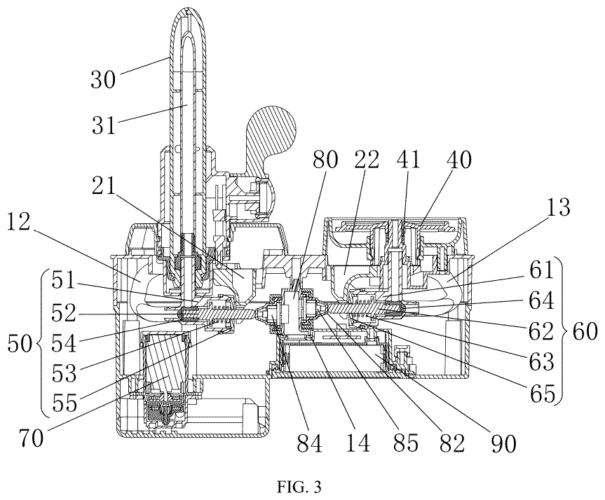

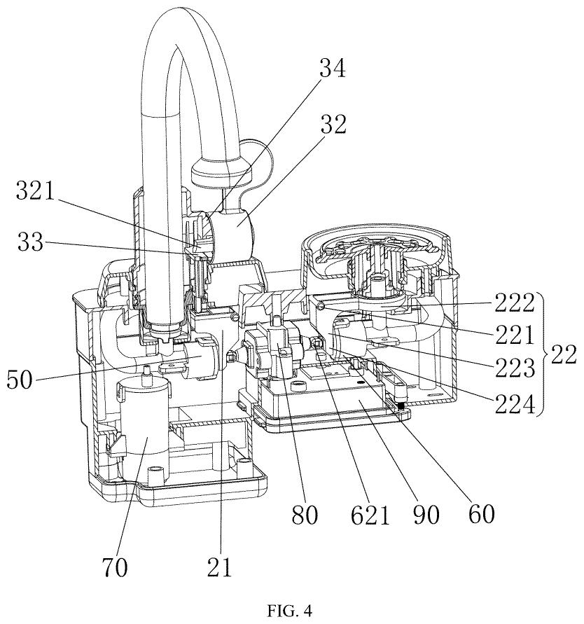

As shown in FIG. 3 and FIG. 4, a first valve mechanism 50, a second valve mechanism 60, and a water pump mechanism 70 are arranged in an inner cavity defined by the base 10 and the upper cover 20. A waterproof switch mechanism 80 is arranged between the first valve mechanism 50 and the second valve mechanism 60. The waterproof switch mechanism 80 is specifically configured to control the water pump mechanism 70. A first driving member 21 for driving the first valve mechanism 50 is arranged below the faucet 30, and a second driving member 22 for driving the second valve mechanism 60 is arranged below the water leakage piston 40.

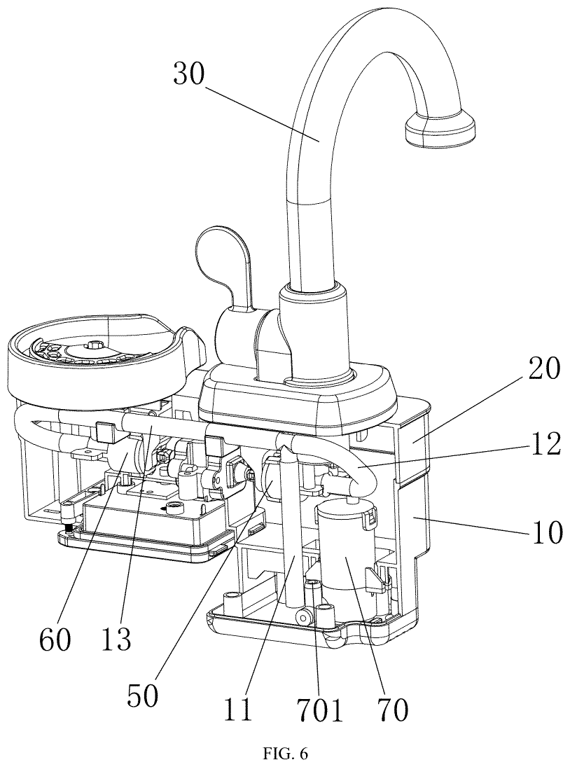

As shown in FIG. 3 and FIG. 10, the waterproof switch mechanism 80 includes a switch body 81, and the waterproof switch mechanism 80 communicates with a power supply mechanism 90. As shown in FIG. 6, a water outlet 701 of the water pump mechanism 70 communicates with a main water pipe 11, and two sides of the main water pipe 11 communicate and are provided with a first branch pipe 12 and a second branch pipe 13 respectively. The first branch pipe 12 communicates with the faucet 30, and the second branch pipe 13 communicates with the water leakage piston 40.

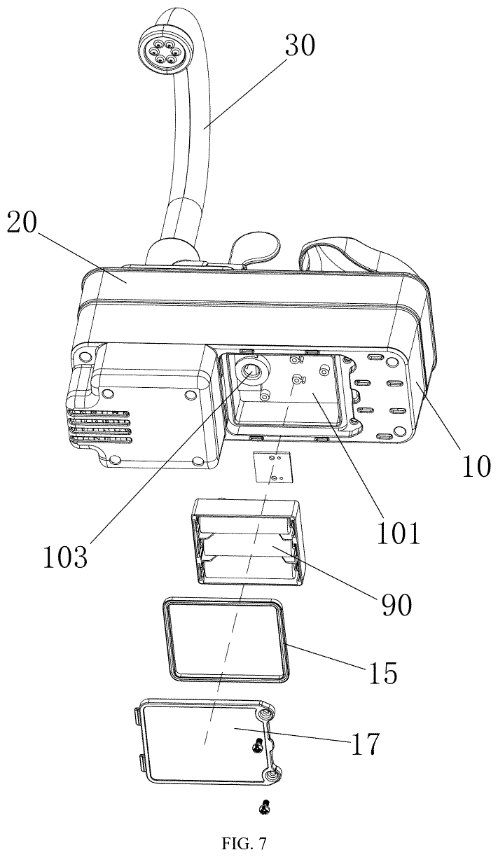

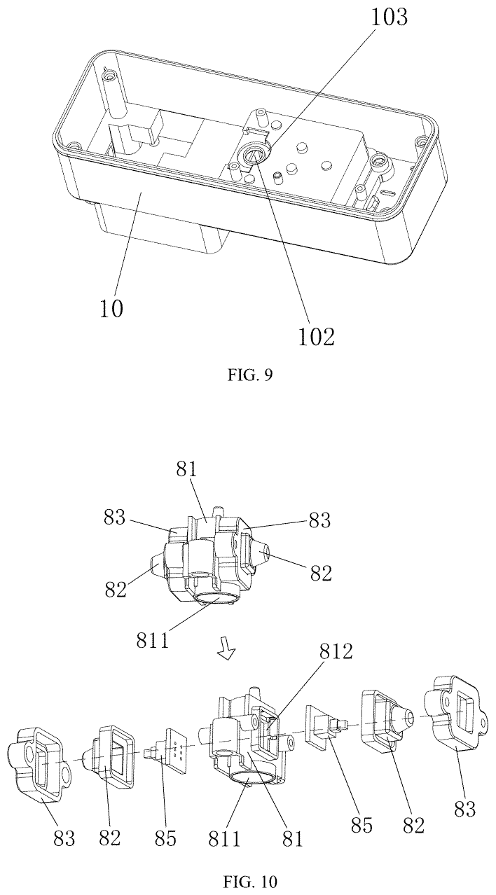

As shown in FIG. 10, the switch body 81 is provided with a first wiring port 811. As shown in FIG. 7 and FIG. 9, the base 10 is provided with an outer recessed cavity 101 for accommodating the power supply mechanism 90, and a second wiring port 102 is provided in the outer recessed cavity 101. The first wiring port 811 of the switch body 81 communicates with the second wiring port 102 of the base 10. As shown in FIG. 3 and FIG. 9, a sinking groove 103 for placing a first waterproof sealing ring 14 is provided at the second wiring port 102, and the first waterproof sealing ring 14 is sandwiched between the base 10 and the switch body 81.

As shown in FIG. 7, a second cover plate 17 is arranged at the outer recessed cavity 101 of the base 10, and a second waterproof sealing ring 15 is sandwiched between the second cover plate 17 and the base 10. When the second cover plate 17 is opened, the power supply mechanism 90 can be taken out from the outer recessed cavity 101 of the base 10 without disassembling the base 10 and the upper cover 20. Three AA batteries are specifically used as the power supply mechanism 90.

During playing, the faucet toy is directly placed into the water, and the water can directly enter the base 10. The power supply mechanism 90 needs to prevent the water outside the base 10 from entering and also needs to prevent water inside the base 10 from entering. The first waterproof sealing ring 14 is sandwiched between the base 10 and the switch body 81. This can prevent the water inside the base 10 from entering the outer recessed cavity 101 of the base 10 through the second wiring port 102, thereby preventing a short circuit of the power supply mechanism 90 caused by water inflow. In addition, the second waterproof sealing ring 15 is sandwiched between the second cover plate 17 and the base 10. The second waterproof sealing ring 15 can prevent the water outside the base 10 from entering, thereby implementing internal and external bidirectional waterproofing of the power supply mechanism 90, and preventing the short circuit of the power supply mechanism 90 caused by water inflow.

As shown in FIG. 10, a left side and a right side of the switch body 81 are provided with lateral grooves 812 for placing travel switches, and each of the lateral grooves 812 is covered with a key cap 82. The key cap 82 is specifically made of silicone. The travel switches each are enclosed in a cavity formed by the key cap 82 and the switch body 81. A side sealing cover 83 for buckling a periphery of the key cap 82 is arranged on each of the left side and the right side of the switch body 81, and the side sealing cover 83 is fixedly connected to the switch body 81. The travel switches specifically include a first travel switch 84 and a second travel switch 85. The first valve mechanism 50 can trigger the first travel switch 84, and the second valve mechanism 60 can trigger the second travel switch 85.

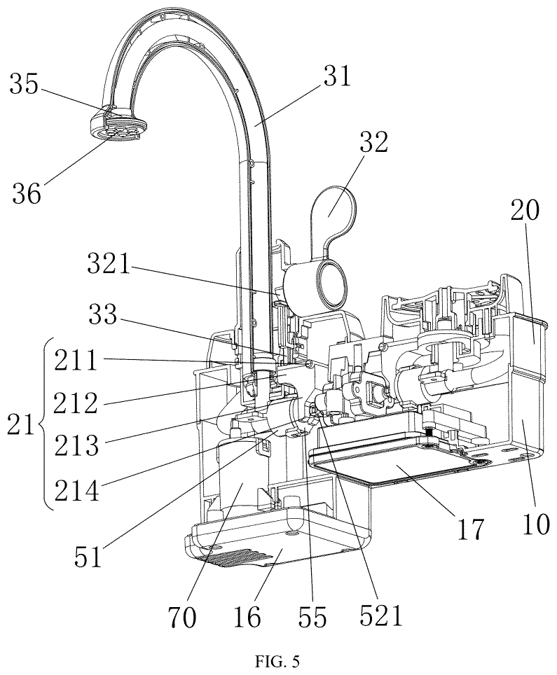

As shown in FIG. 3 and FIG. 5, the first valve mechanism 50 includes a first valve body 51. An upper end of a valve cavity of the first valve body 51 communicates with a water outlet pipe 31 of the faucet 30, and a left side end of the valve cavity of the first valve body 51 communicates with the first branch pipe 12. A first pull rod member 52 is slidably arranged at a right side end of the valve cavity of the first valve body 51, and the first pull rod member 52 is sleeved with a first return spring 53. The first pull rod member 52 is movably connected to the first driving member 21. A first blocking plug 54 is arranged at a left rod end of the first pull rod member 52, and a right rod end of the first pull rod member 52 is configured to press and contact the waterproof switch mechanism 80.

The first valve body 51 is specifically equipped with a first valve cover 55, and the first pull rod member 52 penetrates the first valve cover 55. One end of the first return spring 53 abuts against the first pull rod member 52, and the other end of the first return spring 53 abuts against the first valve cover 55.

The first driving member 21 is provided with a first fulcrum portion 211, a first pressing arm portion 212, and a first warped arm portion 213. The first fulcrum portion 211 is hinged to the upper cover 20. The first pressing arm portion 212 abuts against a rocker switch mechanism of the faucet 30, and the first warped arm portion 213 drives the first pull rod member 52 to slide at the first valve body 51.

The right rod end of the first pull rod member 52 is specifically provided with a first rod head 521, and the first warped arm portion 213 of the first driving member 21 is specifically provided with a first forking finger 214 for forking the first rod head 521. When the first warped arm portion 213 of the first driving member 21 is warped up, the first forking finger 214 at the first warped arm portion 213 pulls the first rod head 521 of the first pull rod member 52, thereby driving the first pull rod member 52 to slide at the first valve body 51.

As shown in FIG. 4 and FIG. 5, the rocker switch mechanism of the faucet 30 specifically includes a rocking handle member 32 and a driven pressing member 33. The rocking handle member 32 is rotatably arranged at a faucet valve body 34, and an eccentric pressure bar 321 is arranged in the rocking handle member 32. The eccentric pressure bar 321 abuts against an upper end of the driven pressing member 33, and a lower end of the driven pressing member 33 abuts against the first pressing arm portion 212 of the first driving member 21.

As shown in FIG. 3 to FIG. 5, when the rocking handle member 32 is rotated, the eccentric pressure bar 321 of the rocking handle member 32 pushes the driven pressing member 33 downward, and the driven pressing member 33 pushes the first warped arm portion 213 of the first driving member 21 to cause the first driving member 21 to rotate counterclockwise around the first fulcrum portion 211. The first warped arm portion 213 of the first driving member 21 pulls the first pull rod member 52, so that the first return spring 53 is elastically deformed. The right rod end of the first pull rod member 52 presses the first travel switch 84 of the waterproof switch mechanism 80, and the first travel switch 84 controls the water pump mechanism 70 to supply water to the faucet 30.

In addition, the left rod end of the first pull rod member 52 drives the first blocking plug 54 to move to the right, thereby releasing blockage of the first valve body 51, so that water can flow into the first valve body 51 from the first branch pipe 12 and flow into the water outlet pipe 31 of the faucet 30 from the first valve body 51, and then the water can be conveyed from the water outlet pipe 31 to the outside.

When the faucet 30 needs to stop water outflow, the rocking handle member 32 is rotated reversely, and the eccentric pressure bar 321 of the rocking handle member 32 releases the pressure on the driven pressing member 33, so that the first return spring 53 recovers from the elastic deformation. The first return spring 53 pushes the first pull rod member 52 to move to the left, so that the first pull rod member 52 returns, and the left rod end of the first pull rod member 52 drives the first warped arm portion 213 of the first driving member 21, to cause the first driving member 21 to rotate clockwise around the first fulcrum portion 211. The first pressing arm portion 212 of the first driving member 21 supports the driven pressing member 33 back to an original position, and the left rod end of the first pull rod member 52 releases the first travel switch 84 of the waterproof switch mechanism 80, so that the water pump mechanism 70 stops pumping water.

In addition, the left rod end of the first pull rod member 52 drives the first blocking plug 54 to move to the left, to block the first valve body 51, so that the water cannot flow into the first valve body 51 from the first branch pipe 12.

As shown in FIG. 3 and FIG. 4, the second valve mechanism 60 includes a second valve body 61. An upper end of a valve cavity of the second valve body 61 communicates with the water leakage piston 40, and a right side end of the valve cavity of the second valve body 61 communicates with the second branch pipe 13. A second pull rod member 62 is slidably arranged at a left side end of the valve cavity of the second valve body 61, and the second pull rod member 62 is sleeved with a second return spring 63. The second pull rod member 62 is movably connected to the second driving member 22. A second blocking plug 64 is arranged at a right rod end of the second pull rod member 62, and a left rod end of the second pull rod member 62 is configured to press and contact the waterproof switch mechanism 80.

The second valve body 61 is specifically equipped with a second valve cover 65, and the second pull rod member 62 penetrates the second valve cover 65. One end of the second return spring 63 abuts against the second pull rod member 62, and the other end of the second return spring 63 abuts against the second valve cover 65.

The second driving member 22 is provided with a second fulcrum portion 221, a second pressing arm portion 222, and a second warped arm portion 223. The second fulcrum portion 211 is hinged to the upper cover 20. The second pressing arm portion 222 abuts against the water leakage piston 40, and the second warped arm portion 223 drives the second pull rod member 62 to slide at the second valve body 61.

The left rod end of the second pull rod member 62 is specifically provided with a second rod head 621, and the second warped arm portion 223 of the second driving member 22 is specifically provided with a second forking finger 224 for forking the second rod head 621. When the second warped arm portion 223 of the second driving member 22 is warped up, the second forking finger 224 at the second warped arm portion 223 pulls the second rod head 621 of the second pull rod member 62, thereby driving the second pull rod member 62 to slide at the second valve body 61.

As shown in FIG. 3 and FIG. 4, when the water leakage piston 40 is pressed downward, the compression spring 41 is elastically deformed, and the water leakage piston 40 presses the second pressing arm portion 222 of the second driving member 22 downward, to cause the second driving member 22 to rotate clockwise around the second fulcrum portion 221. The second warped arm portion 223 of the second driving member 22 pulls the second pull rod member 62, so that the second return spring 63 is elastically deformed. The left rod end of the second pull rod member 62 presses the second travel switch 85 of the waterproof switch mechanism 80, and the second travel switch 85 controls the water pump mechanism 70 to pump water through the second branch pipe 13.

In addition, the right rod end of the second pull rod member 62 drives the second blocking plug 64 to move to the left, thereby releasing the blockage of the second valve body 61, so that accumulated water above the water leakage piston 40 can be pumped away through the second branch pipe 13.

When the water leakage piston 40 is released, the compression spring 41 recovers from the elastic deformation and pushes the water leakage piston 40 upward, so that the water leakage piston 40 returns, and the water leakage piston 40 releases the pressure on the second pressing arm portion 222 of the second driving member 22, so that the second return spring 63 recovers from the elastic deformation. The second return spring 63 pushes the second pull rod member 62 to move to the right, so that the second pull rod member 62 returns. The left rod end of the second pull rod member 62 drives the second warped arm portion 223 of the second driving member 22, and the second driving member 22 rotates counterclockwise around the second fulcrum portion 221 to cause the second driving member 22 to return. The left rod end of the second pull rod member 62 releases the second travel switch 85 of the waterproof switch mechanism 80 to cause the water pump mechanism 70 to stop pumping water.

In addition, the right rod end of the second pull rod member 62 drives the second blocking plug 64 to move to the right, thereby blocking the second valve body 61, so that the water leakage piston 40 stops leaking water downward.

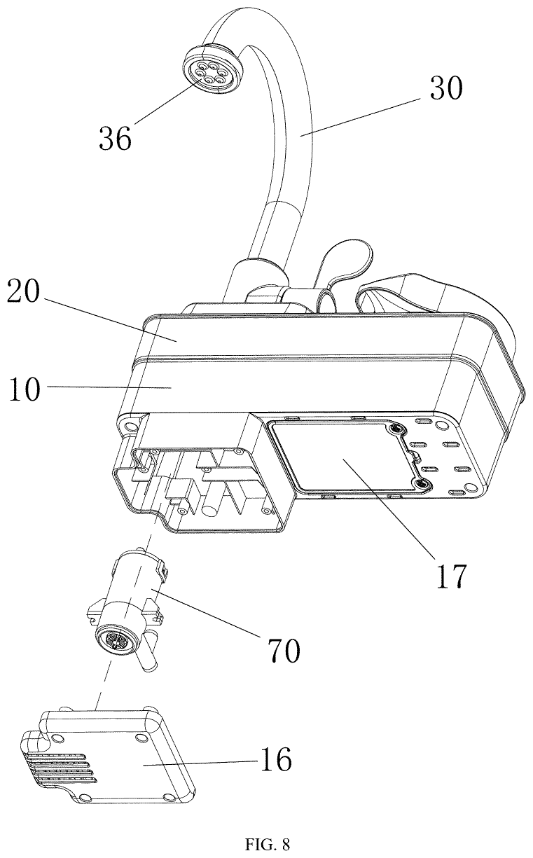

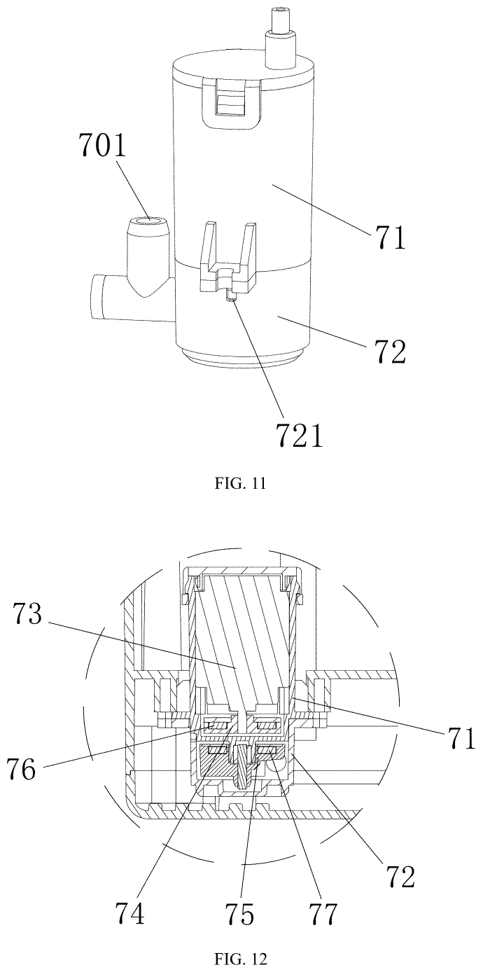

As shown in FIG. 3, FIG. 8, and FIG. 12, the base 10 is provided with a first cover plate 16 below the water pump mechanism 70, and the entire water pump mechanism 70 can be removed from below the base 10 by opening the first cover plate 16. As shown in FIG. 3, FIG. 8, and FIG. 11, the water pump mechanism 70 is vertically arranged on the base 10, and the water pump mechanism 70 includes a water pump housing 71 and a water pump cap 72. The water pump cap 72 is arranged below the water pump housing 71, and a side wall of the water pump cap 72 is provided with an exhaust port 721.

A motor 73 and a turntable member 74 arranged below the motor 73 are arranged in the water pump housing 71, and the turntable member 74 is connected to a motor shaft of the motor 73. A rotating impeller 75 is arranged in the water pump cap 72, and the turntable member 74 is provided with a first magnet 76. A second magnet 77 magnetically attracted to the first magnet 76 is arranged in the rotating impeller 75, and the turntable member 74 drives the rotating impeller 75 to rotate synchronously when rotating.

During playing, the faucet toy is directly placed into water, and some air easily accumulates under the base 10. When the water pump mechanism 70 is operating, the air easily accumulates at the rotating impeller 75. This causes the air to be included when the rotating impeller 75 rotates to pump water, resulting in intermittent water flow conveyed out from the faucet, and seriously affecting fun of playing with the faucet toy. To overcome this technical problem, the exhaust port 721 is provided at the water pump mechanism 70. When the rotating impeller 75 rotates, the accumulated air can be discharged from the exhaust port 721, so that no air is included when the rotating impeller 75 rotates to pump water, thereby ensuring that the faucet continues to convey out stable water flow.

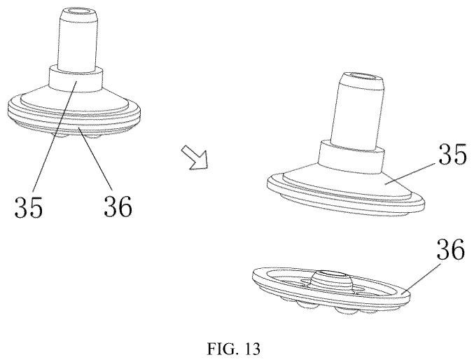

As shown in FIG. 5 and FIG. 13, a showerhead assembly is arranged on an end portion of a water outlet pipe 31 of the faucet 30, and the showerhead assembly includes a water pipe connector 35 and a showerhead member 36. An upper end of the water pipe connector 35 is connected to the water outlet pipe 31, and a lower end of the water pipe connector 35 is snap-fitted with the showerhead member 36. The showerhead member 36 can be directly snap-fitted with the water pipe connector 35, thereby facilitating assembly.

In descriptions of the present application, it should be understood that, orientation or positional relationships indicated by terms “upper”, “lower”, “front”, “rear”, “left”, “right”, “top”, “bottom”, “inner”, “outer”, and the like are orientation or positional relationships based on the accompanying drawings, and are merely intended to facilitate the descriptions of the present application and simplify the descriptions, rather than indicating or implying that a device or element referred to must have a particular orientation or be constructed or operated in a particular orientation. Therefore, these terms cannot be construed as limiting the present application.

It should be understood that although the terms “first”, “second”, and the like are used in the present application to describe various information, the information should not be limited to these terms. These terms are only used to distinguish the same type of information from each other. For example, without departing from the scope of the present application, “first” information may also be referred to as “second” information, and similarly, “second” information may also be referred to “first” information.

The above descriptions are not intended to limit the technical scope of the present application in any way. Any modifications and equivalent changes made to the above embodiments based on the technical essence of the present application still fall within the scope of the technical solutions of the present application.

What is claimed is:

1. A faucet toy implementing circulating water outflow, comprising a base and an upper cover covering above the base, wherein
a faucet and a water leakage piston are arranged on two sides of the upper cover respectively,
a first valve mechanism, a second valve mechanism, and a water pump mechanism are arranged in an inner cavity defined by the base and the upper cover, a waterproof switch mechanism is arranged between the first valve mechanism and the second valve mechanism, a first driving member for driving the first valve mechanism is arranged below the faucet, and when the first driving member drives the first valve mechanism, the first driving member presses and contacts a first travel switch of the waterproof switch mechanism; a second driving member for driving the second valve mechanism is arranged below the water leakage piston, and when the second driving member drives the second valve mechanism, the second driving member presses and contacts a second travel switch of the waterproof switch mechanism; and
the waterproof switch mechanism comprises a switch body, the waterproof switch mechanism communicates with a power supply mechanism through respective wiring holes, the base is provided with an outer recessed cavity for accommodating the power supply mechanism, a water outlet of the water pump mechanism communicates with a main water pipe, two sides of the main water pipe communicate and are provided with a first branch pipe and a second branch pipe respectively, the first branch pipe communicates with the faucet through the first valve mechanism, and the second branch pipe communicates with the water leakage piston through the second valve mechanism.

2. The faucet toy implementing circulating water outflow according to claim 1, wherein the switch body of the waterproof switch mechanism is provided with a first wiring port, a second wiring port is provided at the outer recessed cavity, the first wiring port of the switch body communicates with the second wiring port of the base, and a first waterproof sealing ring is sandwiched between the base and the switch body.

3. The faucet toy implementing circulating water outflow according to claim 2, wherein a second cover plate is arranged at the outer recessed cavity of the base, and a second waterproof sealing ring is sandwiched between the second cover plate and the base.

4. The faucet toy implementing circulating water outflow according to claim 1, wherein a left side and a right side of the switch body are provided with lateral grooves for placing travel switches, each of the lateral grooves is covered with a key cap, the travel switches each are enclosed in a cavity formed by the key cap and the switch body, a side sealing cover for buckling a periphery of the key cap is arranged on each of the left side and the right side of the switch body, and the side sealing cover is fixedly connected to the switch body.

5. The faucet toy implementing circulating water outflow according to claim 1, wherein the first valve mechanism comprises a first valve body, an upper end of a valve cavity of the first valve body communicates with a water outlet pipe of the faucet, a left side end of the valve cavity of the first valve body communicates with the first branch pipe, a first pull rod member is slidably arranged at a right side end of the valve cavity of the first valve body, the first pull rod member is sleeved with a first return spring, the first pull rod member is movably connected to the first driving member, a first blocking plug is arranged at a left rod end of the first pull rod member, and a right rod end of the first pull rod member is configured to press and contact the waterproof switch mechanism.

6. The faucet toy implementing circulating water outflow according to claim 5, wherein the first driving member is provided with a first fulcrum portion, a first pressing arm portion, and a first warped arm portion, the first fulcrum portion is hinged to the upper cover, the first pressing arm portion abuts against a rocker switch mechanism of the faucet, and the first warped arm portion drives the first pull rod member to slide at the first valve body.

7. The faucet toy implementing circulating water outflow according to claim 6, wherein the second valve mechanism comprises a second valve body, an upper end of a valve cavity of the second valve body communicates with the water leakage piston, a right side end of the valve cavity of the second valve body communicates with the second branch pipe, a second pull rod member is slidably arranged at a left side end of the valve cavity of the second valve body, the second pull rod member is sleeved with a second return spring, the second pull rod member is movably connected to the second driving member, a second blocking plug is arranged at a right rod end of the second pull rod member, and a left rod end of the second pull rod member is configured to press and contact the waterproof switch mechanism.

8. The faucet toy implementing circulating water outflow according to claim 7, wherein the second driving member is provided with a second fulcrum portion, a second pressing arm portion, and a second warped arm portion, the first fulcrum portion is hinged to the upper cover, the second pressing arm portion abuts against the water leakage piston, and the second warped arm portion drives the second pull rod member to slide at the second valve body.

9. The faucet toy implementing circulating water outflow according to claim 1, wherein the water pump mechanism is arranged on the base, the water pump mechanism comprises a water pump housing and a water pump cap, the water pump cap is arranged below the water pump housing, and a side wall of the water pump cap is provided with an exhaust port; and
a motor and a turntable member arranged below the motor are arranged in the water pump housing, the turntable member is connected to a motor shaft of the motor, a rotating impeller is arranged in the water pump cap, the turntable member is provided with a first magnet, a second magnet magnetically attracted to the first magnet is arranged in the rotating impeller, and the turntable member drives the rotating impeller to rotate synchronously when rotating.

10. The faucet toy implementing circulating water outflow according to claim 1, wherein a showerhead assembly is arranged on an end portion of a water outlet pipe of the faucet, the showerhead assembly comprises a water pipe connector and a showerhead member, an upper end of the water pipe connector is connected to the water outlet pipe, and a lower end of the water pipe connector is snap-fitted with the showerhead member.
